(19) United States
(12) Patent Application Publication
(10) Pub. No.: US 2022/0342520 A1
(43) Pub. Date: Oct. 27, 2022

(54) DISPLAY CONTROL METHOD, NON-TRANSITORY COMPUTER-READABLE MEDIUM STORING PROGRAM, AND DISPLAY APPARATUS

(71) Applicant: SEIKO EPSON CORPORATION, Tokyo (JP)

(72) Inventor: Yusuke YAMADA, Shiojiri-shi (JP)

(21) Appl. No.: 17/660,429

(22) Filed: Apr. 25, 2022

(30) Foreign Application Priority Data
Apr. 27, 2021 (JP) 2021-075253

(51) Int. Cl. G06F 3/0484; G06F 3/04817; G06F 3/0482

(52) U.S. Cl. CPC G06F 3/0484; G06F 3/04817; G06F 3/0482; G06F 3/04883

(57) ABSTRACT

A display control method for a display apparatus includes displaying a first image, switching the displaying of the first image to a second image in response to a first operation performed by a user, and displaying a related image corresponding to the second image in response to a second operation performed by the user on the second image being displayed.

The present application is based on, and claims priority from JP Application Serial Number 2021-075253, filed Apr. 27, 2021, the disclosure of which is hereby incorporated by reference herein in its entirety.

### BACKGROUND

### 1. Technical Field

The present disclosure relates to a display control method, a non-transitory computer-readable medium storing a program, and a display apparatus.

### 2. Related Art

Apparatuses for performing processing in response to an operation performed by a user are known. JP-A-2020-123234 discloses an information processing apparatus that displays a plurality of images of pages of a document and attaches electronic sticky notes to corresponding images in response to attaching operations received from a user.

JP-A-2020-123234 enables the user to readily know whether images of interest are included or to locate images of interest with electronic sticky notes; however, it fails to provide the user with the contents of the images of interest.

### SUMMARY

According to an aspect to solve the above-described problem, a display control method for a display apparatus includes displaying a first image, switching the displaying of the first image to a second image in response to a first operation performed by a user, and displaying a related image corresponding to the second image in response to a second operation performed by the user on the second image being displayed.

According to another aspect to solve the above-described problem, a non-transitory computer-readable storage medium storing a program for causing a processor in a display apparatus to perform displaying a first image, switching the displaying of the first image to a second image in response to a first operation performed by a user, and displaying a related image corresponding to the second image in response to a second operation performed by the user on the second image.

According still another aspect to solve the above-described problem, a display apparatus includes an operation unit configured to receive a user operation, a display unit, and a display control unit configured to switch a first image being displayed on the display unit to a second image in response to a first operation received by the operation unit. The display control unit displays a related image corresponding to the second image in response to the operation unit receiving a second operation on the second image.

### BRIEF DESCRIPTION OF THE DRAWINGS

FIG. 1 illustrates a configuration of a printing system.

FIG. 2 illustrates a list application UI.

FIG. 3 illustrates a selected application UI.

FIG. 4 illustrates a selected application UI.

FIG. 5 illustrates a selected application UI.

FIG. 6 illustrates a list application UI.

FIG. 7 is a flowchart illustrating the operation performed by a display control unit.

FIG. 8 is a flowchart illustrating the operation performed by a display control unit.

FIG. 9 illustrates a case in which related images are used.

FIG. 10 illustrates a case in which a back icon is used.

### DESCRIPTION OF EXEMPLARY EMBODIMENTS

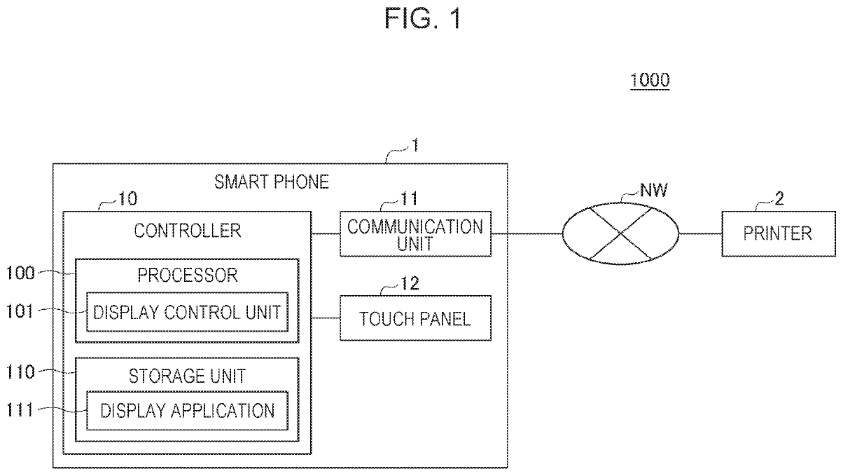

FIG. 1 illustrates a configuration of a printing system 1000. The printing system 1000 includes a smart phone 1 and a printer 2. The smart phone 1 and the printer 2 are coupled to a network NW. The network NW may be a local network or a global network including the Internet, a private link, and a public link. The smart phone 1 is an example display apparatus.

The smart phone 1 may be a notebook personal computer (PC), a desktop PC, or a tablet terminal. A display application 111, which is an application program for displaying images in accordance with document data, is installed in the smart phone 1. The document data is data representing a document consisting of one or more pages. The document data may be in Word format, Portable Document Format (PDF), or the like. The display application 111 has a function of displaying page images PG that correspond to images of pages in a document based on document data. The display application 111 has a function of displaying thumbnail images SG of pages in a document based on document data in accordance with the document data. The display application 111 has a function of generating print data complying with a command system of the printer 2 coupled to the smart phone 1 or a command system of another printer (not illustrated). The display application 111 has a function of transmitting generated print data to the printer 2. The display application 111 is an example program.

The printer 2 is used to print images onto print media. Print media may be any media, such as cut paper of a predetermined size, roll paper, or a synthetic resin sheet. The printer 2 may employ any printing system, such as a dot impact system, a dye-sublimation system, or a thermal system. The printer 2 according to the embodiment employs an ink jet printing system.

Hereinafter, a configuration of the smart phone 1 is described. The smart phone 1 includes a controller 10, a communication unit 11, and a touch panel 12. The touch panel 12 is an example of an operation unit and a display unit.

The controller 10 includes a processor 100 for implementing a program, such as a central processing unit (CPU) or a micro-processing unit (MPU), and a storage unit 110. The controller 10 controls components in the smart phone 1. The processor 100 reads a program stored in the storage unit 110 and executes various types of processing using hardware and software. The processor 100 executes the display application 111 stored in the storage unit 110, thereby functioning as a display control unit 101.

The storage unit 110 is a memory device that stores programs to be executed by the processor 100 and data to be processed by the processor 100. The storage unit 110 stores the display application 111 to be executed by the processor 100 and various types of programs and data. The storage unit 110 has a nonvolatile storage area and a volatile storage area. The volatile storage area may function as a work area for the processor 100.

The communication unit 11 is a communication interface for communication in accordance with a predetermined communication standard and communicates with the printer 2 via the network NW under the control of the controller 10. The communication unit 11 transmits print data output by the display application 111 to the printer 2. Print data includes print conditions and print commands. The communication unit 11 receives document data from a server device or a client device (not illustrated) via the network NW.

The touch panel 12 includes a display panel, such as a liquid crystal display panel, and a touch sensor that is disposed on the display panel or formed integrally. The display panel displays various kinds of images under the control of the controller 10. The touch sensor detects a touch operation and outputs the information to the controller 10. The controller 10 executes processing corresponding to the touch operation in accordance with the input from the touch sensor.

As described above, the processor 100 functions as the display control unit 101. The display control unit 101 communicates with a device coupled to the network NW via the communication unit 11. The display control unit 101 transmits print data to the printer 2 via the communication unit 11. The display control unit 101 receives document data from a server device or a client device (not illustrated) via the communication unit 11.

The display control unit 101 causes the touch panel 12 to display a plurality of user interface screens. When a plurality of user interface screens are not distinguished from each other, the user interface screens are referred to as an application UI 202. The display control unit 101 causes the touch panel 12 to display the application UI 202, thereby providing various kinds of user information and receiving a variety of user instructions.

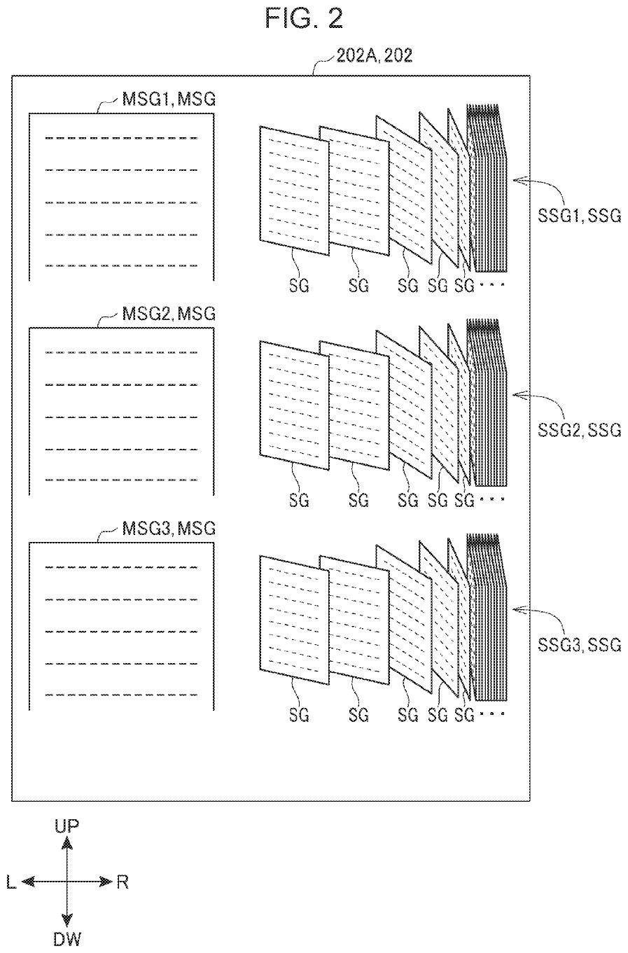

The application UI 202 will be described with reference to FIG. 2 to FIG. 6. In FIGS. 2 to 6, an upward direction is indicated as UP, a downward direction is indicated as DW, a leftward direction is indicated as L, and a rightward direction is indicated as R.

The display control unit 101 performs control processing for displaying a list application UI 202A for displaying a list of document data. The list application UI 202A is included in the application UI 202. FIG. 2 illustrates an example of the list application UI 202A.

The list application UI 202A displays a combination of a thumbnail image group SSG and a main thumbnail image MSG for each piece of data. In the description below, a thumbnail image group SSG of n-th document data is referred to as an n-th thumbnail image group SSGn, and a main thumbnail image MSG of n-th document data is referred to as an n-th main thumbnail image MSGn, where n is an integer greater than zero.

The list application UI 202A illustrated in FIG. 2 displays a combination of a first thumbnail image group SSG1 and a first main thumbnail image MSG1 at a predetermined position in accordance with first document data. The list application UI 202A displays a combination of a second thumbnail image group SSG2 and a second main thumbnail image MSG2 in accordance with second document data. The combination of the second thumbnail image group SSG2 and the second main thumbnail image MSG2 is displayed below the combination of the first thumbnail image group SSG1 and the first main thumbnail image MSG1. The list application UI 202A displays a combination of a third thumbnail image group SSG3 and a third main thumbnail image MSG3 in accordance with third document data. The combination of the third thumbnail image group SSG3 and the third main thumbnail image MSG3 is displayed below the combination of the second thumbnail image group SSG2 and the second main thumbnail image MSG2.

A thumbnail image group SSG is an image group of thumbnail images SG aligned in the horizontal direction. Thumbnail images SG in a thumbnail image group SSG are displayed such that each image SG is viewed from a predetermined point. A thumbnail image SG of a thumbnail image group SSG corresponds to a page of a document based on the corresponding document data. The horizontal direction is an example predetermined direction.

A main thumbnail image MSG is a thumbnail image SG corresponding to a main page of document data. The main page may be a top page of document data. The list application UI 202A may display, as a main thumbnail image MSG, part of a thumbnail image SG of a predetermined page or display the entire thumbnail image SG of a predetermined page.

A combination of a thumbnail image group SSG and a main thumbnail image MSG can be selected on the list application UI 202A via a touch operation. In response to the combination being selected on the list application UI 202A, the display control unit 101 causes a selected application UI 202B that relates to the selected document to be displayed. The selected application UI 202B is included in the application UI 202.

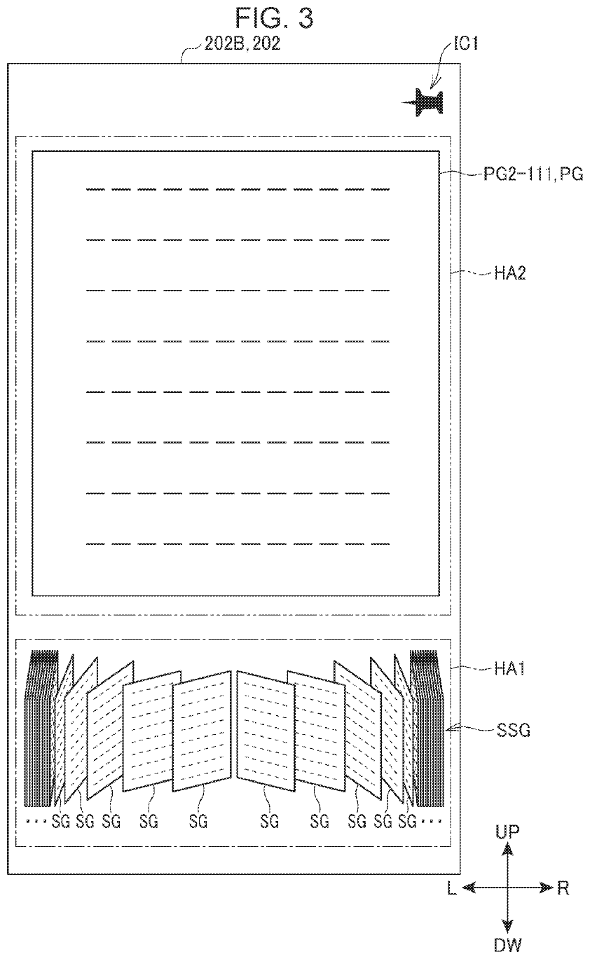

FIG. 3 illustrates an example of the selected application UI 202B.

The selected application UI 202B includes a thumbnail image group display area HA1 and a page image display area HA2. The thumbnail image group display area HA1 is an example of a first area. The page image display area HA2 is an example of a second area.

The thumbnail image group display area HA1 is an area for displaying a thumbnail image group SSG selected on the list application UI 202A. When a combination of a first main thumbnail image MSG1 and a first thumbnail image group SSG1 is selected on the list application UI 202A, the thumbnail image group display area HA1 displays the first thumbnail image group SSG1 included in the selected combination.

The display control unit 101 changes the state of the display of the thumbnail image group SSG in response to a predetermined touch operation performed by an indicator such as a finger, for example, a flicking operation or a sliding operation, in the thumbnail image group display area HA1.

When a rightward sliding operation is performed, the thumbnail images SG are moved from the left to the right by an amount of rightward movement of the indicator in the thumbnail image group display area HA1. When a leftward sliding operation is performed, the thumbnail images SG are moved from the right to the left by an amount of leftward movement of the indicator in the thumbnail image group display area HA1.

The page image display area HA2 is an area for displaying a page image PG of a page corresponding to a thumbnail image SG selected in the thumbnail image group display area HA1. In the description below, a page image PG that corresponds to an m-th page of a document based on n-th document data is indicated by PG followed by the numbers n and m in a form of n-m, where m is an integer greater than zero. In FIG. 3, a page image PG2-111 is a page image PG that corresponds to page 111 of a document based on the second document data.

The page image display area HA2 receives a switching operation in response to a predetermined touch operation performed by a user. Predetermined touch operations include flicking operations and sliding operations. The switching operation is an example first operation. In response to receiving a switching operation in the page image display area HA2, the display control unit 101 switches a page image PG being displayed.

In response to a rightward predetermined touch operation in the page image display area HA2, a page image PG of a previous page with respect to the page corresponding to the page image PG being displayed at the time of the switching operation is displayed in the page image display area HA2. In response to a leftward predetermined touch operation in the page image display area HA2, a page image PG of a subsequent page with respect to the page corresponding to the page image PG being displayed at the time of the switching operation is displayed in the page image display area HA2.

In response to a rightward sliding operation in the state in FIG. 3, a page image PG2-110 is displayed in the page image display area HA2. In response to a leftward sliding operation in the state in FIG. 3, a page image PG2-112 is displayed in the page image display area HA2.

In response to the page image PG being switched in the page image display area HA2, in the thumbnail image group display area HA1, the state of displaying the thumbnail image group SSG is changed and a thumbnail image SG corresponding to the image switched is provided at a substantially center position in the horizontal direction.

The selected application UI 202B has a registered icon IC1 at a top right end. The registered icon IC1 is used by users to mark a desired page. The selected application UI 202B receives registration operations or deregistration operations performed by users via the registered icon IC1. The display state of the registered icon IC1 is switched between an untagged state and a tagged state in response to a predetermined touch operation, such as a tapping operation. The tapping operation is an operation of tapping the display surface of the touch panel 12. The display state of the registered icon IC1 in FIG. 3 is an untagged state. In response to the registered icon IC1 being tapped in the untagged state, the display state is switched to a tagged state. In response to the registered icon IC1 being operated by a user via a predetermined touch operation in the tagged state, the display state is switched to an untagged state. The selected application UI 202B receives registration operations performed by users via the registered icon IC1 that is in an untagged state. The selected application UI 202B receives deregistration operations performed by users via the registered icon IC1 that is in a tagged state. The registration operation is an example second operation.

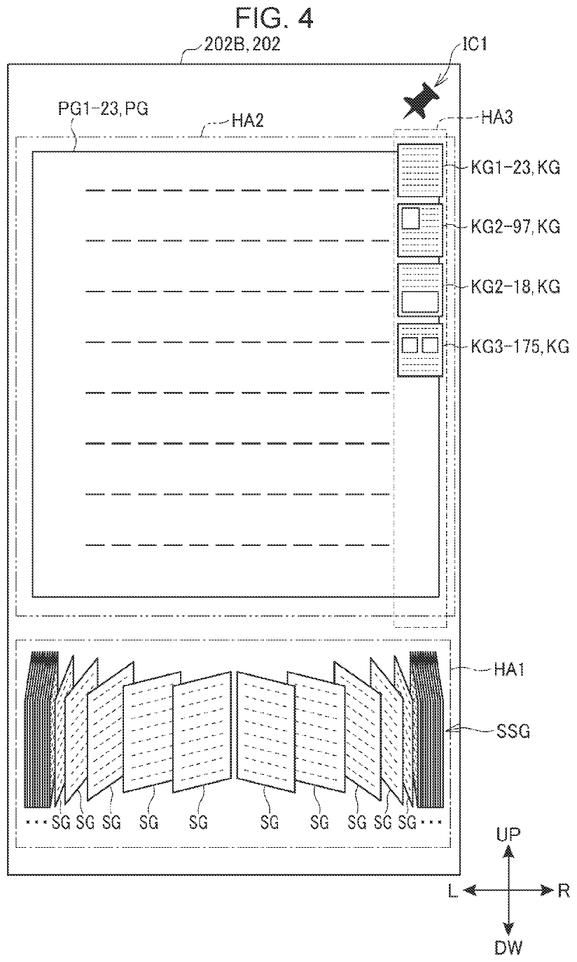

FIG. 4 illustrates an example selected application UI 202B following a user operation of tagging a desired page.

In response to a registration operation via the registered icon IC1 in an untagged state, a related image KG that corresponds to the page image PG of the tagged page is displayed below the registered icon IC1 on the selected application UI 202B. The related image KG corresponds to the page image PG of the tagged page and is an image relating to the page image PG. The related image KG shows the content of the page of the corresponding page image PG. The related image KG may be a thumbnail image of the corresponding page image PG or an image showing part of the content of the page of the corresponding page image PG. The related image KG is displayed in a related image display area HA3 that is below the registered icon IC1 and extends in the vertical direction.

In the description below, a related image KG corresponding to a page image PGn-m that is a page image PG corresponding to an m-th page of a document based on n-th document data is indicated by KG followed by the numbers n and m in a form of n-m.

FIG. 4 illustrates four related images KG: related images KG1-23, KG2-97, KG2-18, and KG3-175. The related image KG1-23 is a related image KG that corresponds to a page image PG of page 23 of a document based on the first document data. The related image KG2-97 is a related image KG that corresponds to a page image PG of page 97 of a document based on the second document data. The related image KG2-18 is a related image KG that corresponds to a page image PG of page 18 of the document based on the second document data. The related image KG3-175 is a related image KG that corresponds to a page image PG of page 175 of a document based on the third document data.

When a plurality of images are tagged as desired pages, a plurality of related images KG are aligned and displayed in order of tagging in the vertical direction in the related image display area HA3. In the related image display area HA3, an upper limit of the number of displayable related images KG is set. In response to a scrolling operation in the related image display area HA3, the display control unit 101 displays the related images KG that have been hidden in the related image display area HA3.

FIG. 4 illustrates the related image KG1-23 that is newly displayed in response to a registration operation via the registered icon IC1 on the selected application UI 202B displaying the page image PG1-23. FIG. 4 illustrates the related images KG that correspond to newly tagged pages, which are displayed in the related image display area HA3. In FIG. 4, the related image KG1-23 is displayed above the related images KG2-97, KG2-18, and KG3-175. When the related image KG1-23 is newly displayed, the display of the related images KG2-97, KG2-18, and KG3-175 is maintained unless the registered icon IC1 is not operated with respect to the selected application UI 202B that is displaying the corresponding page image PG.

The related image KG2-97 is displayed in response to a registration operation on the selected application UI 202B that displays the page image PG2-97 after the page corresponding to the related image KG2-18 has been tagged. After the page corresponding to the related image KG3-175 has been tagged, the related image KG2-18 is displayed in response to a registration operation on the selected application UI 202B that displays the page image PG2-18. The related image KG3-175 is displayed in response to a registration operation on the selected application UI 202B that displays the page image PG3-175 in a state in which no page has been tagged.

Each related image KG displayed in the related image display area HA3 receives a selection operation in response to a predetermined touch operation, such as a tapping operation. The selection operation is an example third operation. In response to a selection operation on a related image KG, the display control unit 101 displays a page image PG corresponding to the selected related image KG in the page image display area HA2. In FIG. 4, in response to a selection operation on the related image KG2-97, the display control unit 101 displays the page image PG2-97 in the page image display area HA2.

In response to a selection operation on a related image KG, the display control unit 101 displays a back icon IC2 on the selected application UI 202B.

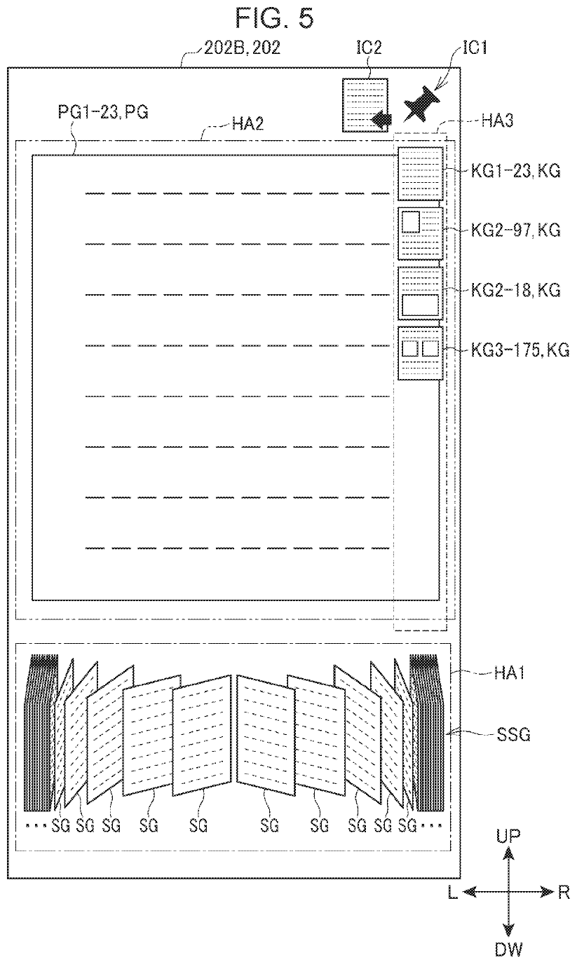

FIG. 5 illustrates an example of the selected application UI 202B that displays the back icon IC2.

FIG. 5 illustrates the selected application UI 202B on which the related image KG1-23 is selected from the four related images KG in FIG. 4 when a page image PG other than the page image PG1-23, the page image PG2-97, the page image PG2-18, and the page image PG3-175 is displayed in the page image display area HA2. The selected application UI 202B in FIG. 5 displays the page image PG1-23 in the page image display area HA2.

The back icon IC2 is displayed to the left of the registered icon IC1. The back icon IC2 is used to switch the page image PG displayed in the page image display area HA2 to a page image PG that is displayed immediately before the related image KG is selected. The back icon IC2 receives a back operation via a predetermined touch operation, such as a tapping operation. In response to a back operation on the back icon IC2, the display control unit 101 displays the page image PG that is displayed immediately before the related image KG is selected in the page image display area HA2. The display control unit 101 displays a thumbnail image group SSG corresponding to the page image PG being displayed in the thumbnail image group display area HA1.

In FIG. 5, it is assumed that a page image PG2-7 is the page image PG that is displayed before the related image KG1-23 is selected. In this case, in response to a predetermined touch operation on the back icon IC2 in FIG. 5, the display control unit 101 displays the page image PG2-7 in the page image display area HA2. The display control unit 101 displays a second thumbnail image group SSG2 in the thumbnail image group display area HA1.

In response to an operation of tagging a desired page via the registered icon IC1, a related image KG is displayed on the list application UI 202A.

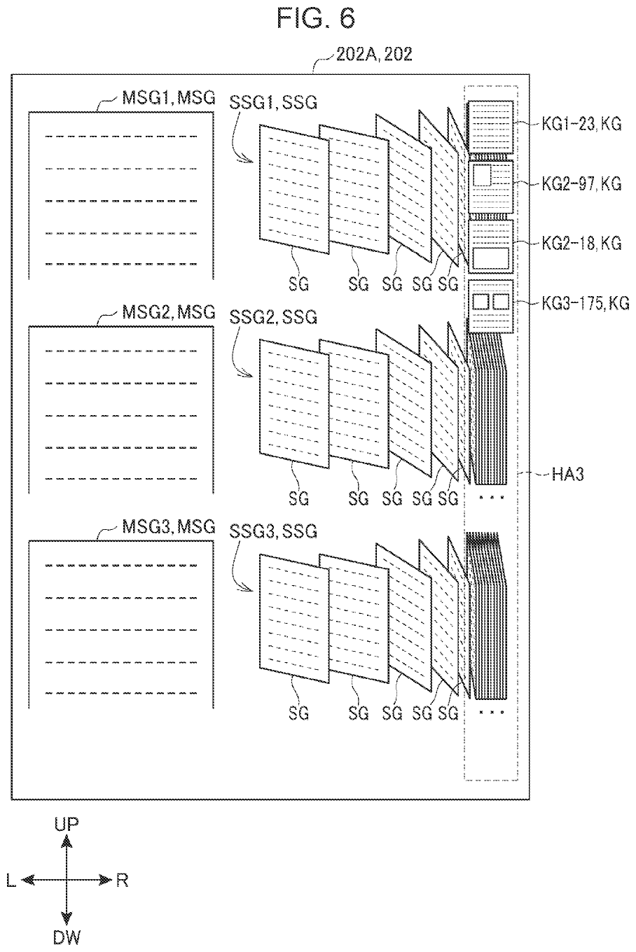

FIG. 6 illustrates an example of the list application UI 202A on which related images KG are displayed.

The related images KG are displayed at a right end of the list application UI 202A. The related images KG are displayed in the related image display area HA3 extending in the vertical direction on the list application UI 202A. FIG. 6 illustrates four related images KG: related images KG1-23, KG2-97, KG2-18, and KG3-175.

Each related image KG displayed on the list application UI 202A receives a selection operation in response to a predetermined touch operation, such as a tapping operation. In response to a selection operation on a related image KG, the display control unit 101 displays the selected application UI 202B that displays a page image PG corresponding to the selected related image KG in the page image display area HA2.

When a selection operation on the related image KG1-23 is received in FIG. 6, the display control unit 101 causes the touch panel 12 to display the selected application UI 202B displaying the page image PG1-23 in the page image display area HA2 and the first thumbnail image group SSG1 in the thumbnail image group display area HA1.

In response to receiving a selection operation on a related image KG on the list application UI 202A, the display control unit 101 may cause a back icon IC2 to be displayed. When displaying a back icon IC2, the display control unit 101 causes the back icon IC2 for returning to the page image PG that was displayed immediately before in the page image display area HA2 is to be displayed.

Next, the operation of the display control unit 101 is described. The operation relating to related images KG and the operation relating to the back icon IC2 are described.

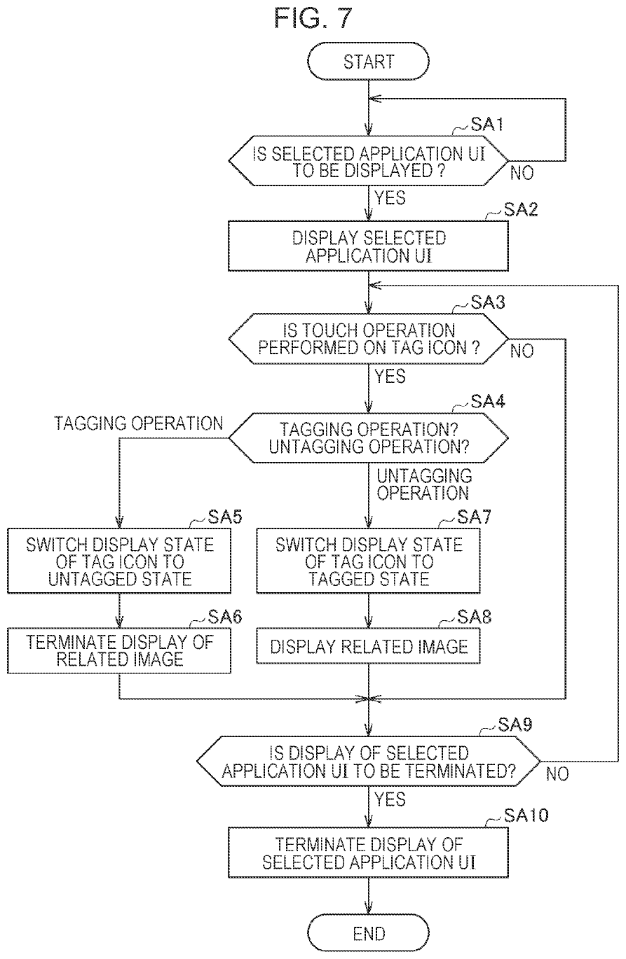

The operation relating to related images KG is described with reference to FIG. 7. FIG. 7 is a flowchart illustrating the operation performed by the display control unit 101 in the smart phone 1.

The display control unit 101 in the smart phone 1 determines whether to display a selected application UI 202B (step SA1).

In response to the display control unit 101 determining to display a selected application UI 202B (step SA1: YES), the display control unit 101 causes the touch panel 12 to display the selected application UI 202B (step SA2).

In step SA2, when a page has already been tagged, the display control unit 101 causes the selected application UI 202B that displays a related image KG to be displayed.

The display control unit 101 determines whether a touch operation is performed on the registered icon IC1 (step SA3).

In response to the display control unit 101 determining that no touch operation is performed on the registered icon IC1 (step SA3: NO), the display control unit 101 performs the processing in step SA7.

In response to the display control unit 101 determining that a touch operation is performed on the registered icon IC1 (step SA3: YES), the display control unit 101 determines whether the operation via the registered icon IC1 is a registration operation or a deregistration operation (step SA4).

In response to the display control unit 101 determining that the touch operation is a deregistration operation (step SA4: deregistration operation), the display control unit 101 switches the display state of the registered icon IC1 to an untagged state (step SA5).

The display control unit 101 terminates display of the related image KG corresponding to the page image PG being displayed on the selected application UI 202B (step SA6).

Returning to the description of step SA4, in response to the display control unit 101 determining that the touch operation is a registration operation (step SA4: registration operation), the display control unit 101 switches the display state of the touched registered icon IC1 to a tagged state (step SA7).

The display control unit 101 displays the related image KG corresponding to the page image PG being displayed on the selected application UI 202B (step SA8).

The display control unit 101 determines whether to terminate the display of the selected application UI 202B (step SA9). The display control unit 101 determines whether to terminate the display of the selected application UI 202B in accordance with whether an instruction described below is received. The instruction for terminating the display may be a user instruction for terminating the display application 111 or a user instruction for switching to the list application UI 202A.

In response to the display control unit 101 determining not to terminate the display of the selected application UI 202B (step SA9: NO), the display control unit 101 returns the processing to step SA3.

In response to the display control unit 101 determining to terminate the display of the selected application UI 202B (step SA9: YES), the display control unit 101 causes the touch panel 12 to terminate the display of the selected application UI 202B (step SA10).

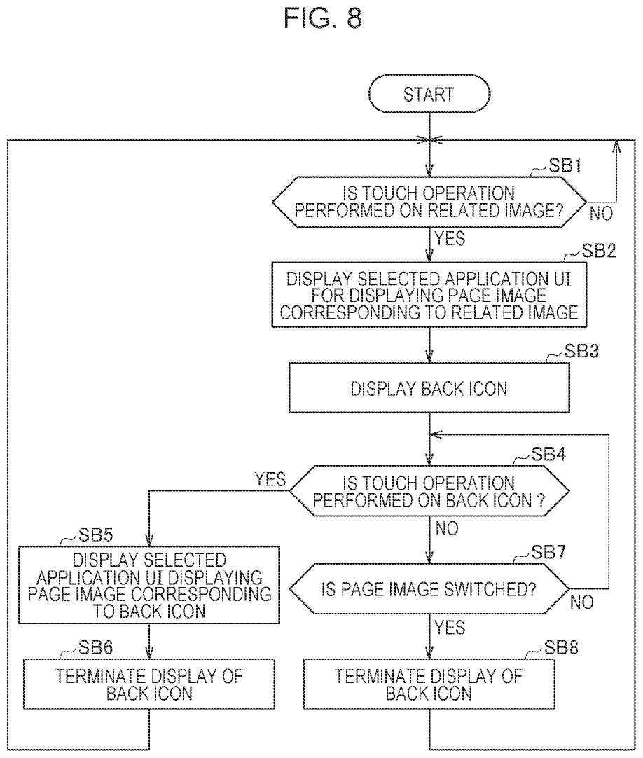

Next, the operation of the smart phone 1 relating to the back icon IC2 is described. FIG. 8 is a flowchart illustrating the operation performed by the display control unit 101 in the smart phone 1.

The display control unit 101 determines whether a touch operation is performed on a related image KG (step SB1).

In response to determining a touch operation on a related image KG (step SB1: YES), the display control unit 101 causes a selected application UI 202B for displaying a page image PG corresponding to the related image KG to be displayed (step SB2).

In displaying the selected application UI 202B, the display control unit 101 causes a back icon IC2 to be displayed on the selected application UI 202B (step SB3).

The display control unit 101 determines whether a touch operation is performed on the back icon IC2 (step SB4).

In response to determining that a touch operation is performed on the back icon IC2 (step SB4: YES), the display control unit 101 causes a page image PG corresponding to the back icon IC2 to be displayed on the selected application UI 202B (step SB5).

In displaying the page image PG corresponding to the back icon IC2 on the selected application UI 202B, the display control unit 101 terminates the display of the back icon IC2 (step SB6).

Returning to the description in step SB4, in response to the display control unit 101 determining that no touch operation is performed on the back icon IC2 (step SB4: NO), the display control unit 101 determines whether the display of the page image PG is switched (step SB7).

In response to the display control unit 101 determining that the display of the page image PG is not switched (step SB7: NO), the display control unit 101 returns the processing to step SB4.

In response to the display control unit 101 determining that the display of the page image PG is switched (step SB7: YES), the display control unit 101 terminates the display of the back icon IC2 (step SB8).

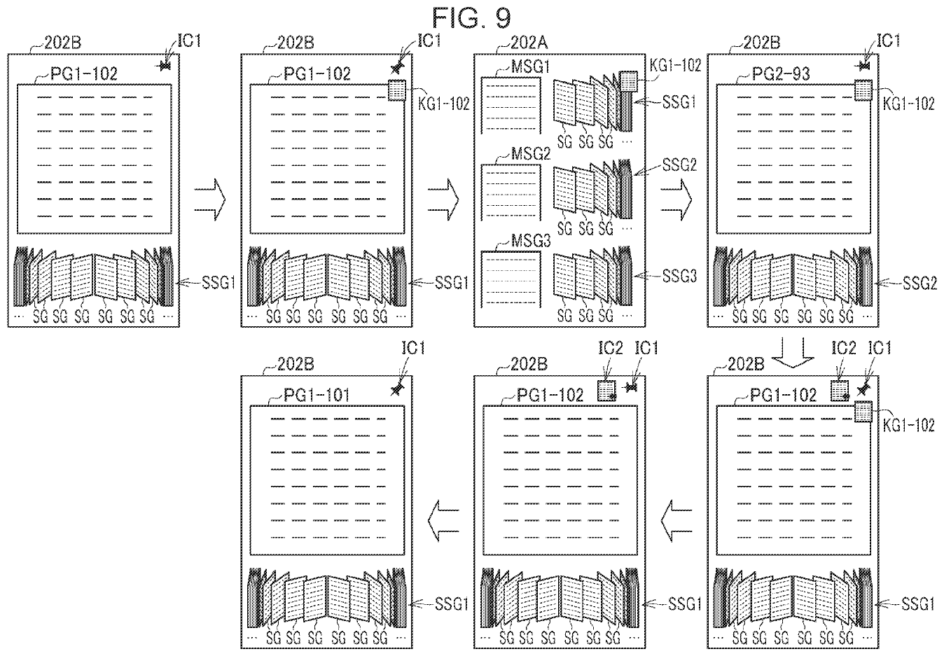

A case in which a related image KG is used is described with reference to FIG. 9. FIG. 9 illustrates a case in which a related image KG is used.

FIG. 9 illustrates a case in which when a user is viewing a document based on first document data, a document based on second document data is temporarily displayed, and the user then views the document based on the first document data again.

As illustrated in FIG. 9, in response to a registration operation in a state in which the page image PG1-102 is displayed, the display control unit 101 switches the registered icon IC1 to a tagged state and causes the related image KG1-102 to be displayed.

As illustrated in FIG. 9, the display control unit 101 causes a list application UI 202A to be displayed in response to a user operation. The related image KG1-102 is displayed on the list application UI 202A.

When the user selects and views the document based on the second document data and selects the related image KG1-102 in a state in which the page image PG2-93 is displayed, the display control unit 101 causes the page image PG1-102 and a back icon IC2 to be displayed as in FIG. 9.

As illustrated in FIG. 9, in response to a touch operation on the registered icon IC1 in the tagged state, the display control unit 101 switches the registered icon IC1 to an untagged state and terminates the display of the related image KG1-102.

As illustrated in FIG. 9, in response to switching the display of the page image PG to another page image PG, the display control unit 101 terminates the display of the back icon IC2.

As described above, the user can readily return from the second document data to the first document data without displaying the list application UI 202A and selecting the first document data.

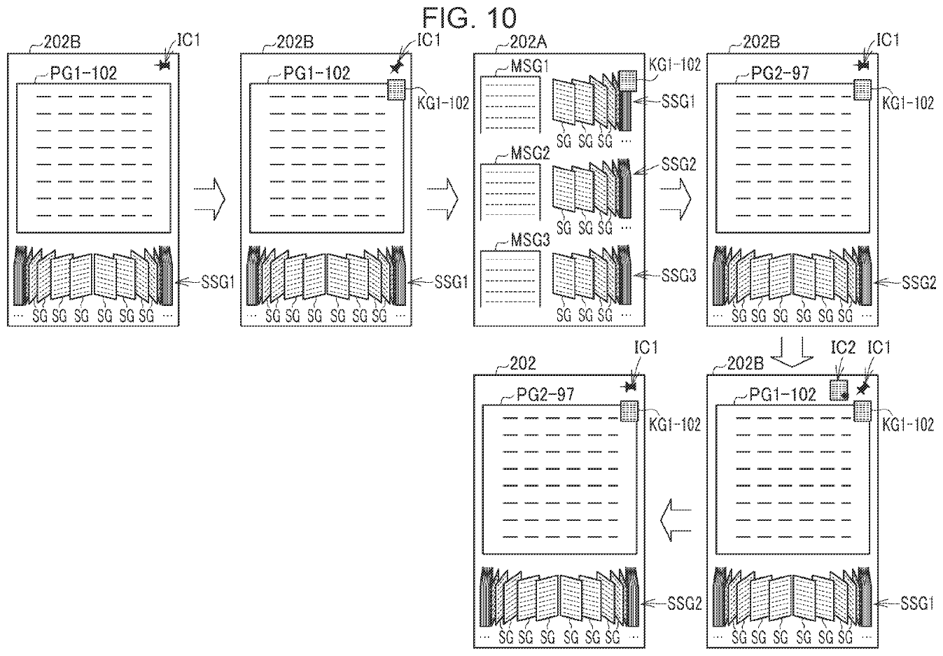

A case in which a back icon IC2 is used is described with reference to FIG. 10. FIG. 10 illustrates a case in which the back icon IC2 is used. FIG. 10 illustrates a case in which when a user is viewing a document based on second document data, the page image PG1-102 corresponding to page 102 of a document based on first document data is temporarily displayed, and the user then views the document based on the second document data again.

As illustrated in FIG. 10, in response to a registration operation in a state in which the page image PG1-102 is displayed, the display control unit 101 switches the registered icon IC1 to a tagged state and causes the related image KG1-102 to be displayed.

As illustrated in FIG. 10, the display control unit 101 causes a list application UI 202A to be displayed in response to a user operation. The related image KG1-102 is displayed on the list application UI 202A.

When the user views the document based on the second document data and touches the related image KG1-102 in a state in which the page image PG2-97 is displayed, the display control unit 101 causes the page image PG1-102 and the back icon IC2 to be displayed as in FIG. 10.

When the user touches the back icon IC2, the display control unit 101 causes the page image PG2-97 that is displayed before the related image KG1-102 is selected to be displayed as illustrated in FIG. 10. The user can use the back icon IC2 to readily cause the image to be displayed, viewing of which has been discontinued by the user, by using the back icon IC2 without displaying the list application UI 202A again to select the second document data.

### Second Embodiment

Other embodiments are described. In the first embodiment, a page image PG and a thumbnail image group SSG are displayed on a selected application UI 202B. In the second embodiment, a page image PG is displayed, but a thumbnail image group SSG is not displayed, on a selected application UI 202B.

### Third Embodiment

In the first embodiment, a related image KG is operated by a user to display a page image PG corresponding to the related image KG. In the third embodiment, a related image KG may be operated to cause the touch panel 12 to preview a page image PG corresponding to the related image KG. Previewing shows an image of a print product to be produced by the printer 2.

### Fourth Embodiment

In the first embodiment, a related image KG is operated by a user to display a page image PG corresponding to the related image KG. In the fourth embodiment, a related image KG may be operated to cause the controller 10 to generate and output print data relating to a page shown by a page image PG corresponding to the related image KG. The controller 10 generates the print data relating to the page corresponding to the operated related image KG and outputs the generated print data to the printer 2. The printer 2 performs printing in accordance with the generated print data.

According to the above-described embodiments, the following advantages can be obtained. In the description below, a first page image PG, a second page image PG, and a third page image PG do not denote specific page images PG. A first page image PG denotes a page image PG, a second page image PG denotes a page image PG different from the first page image PG, and a third page image PG denotes a page image PG different from the first page image PG and the second page image PG. A first page image PG is an example of a first image, a second page image PG is an example of a second image, and a third page image PG is an example of a third image.

In the description of advantages below, a first thumbnail image SG and a second thumbnail image SG do not denote specific thumbnail images SG. A first thumbnail image SG denotes a thumbnail image SG, and a second thumbnail image SG denotes a thumbnail image SG different from the first thumbnail image SG.

As described above, a display control method for the smart phone 1 includes displaying a first page image PG, switching the displaying of the first page image PG to a second page image PG in response to a switching operation performed by a user, and displaying a related image KG corresponding to the second page image PG in response to a registration operation performed by the user on the second page image PG being displayed.

With this configuration, a related image KG corresponding a page image PG of user's interest is displayed, enabling the user to readily check the content of the desired page image PG.

The display control method for the smart phone 1 may further include switching the displaying of the second image PG to the first image PG, and switching the displaying of the first image PG to the second image PG in response to a selection operation performed by the user on the related image KG in a state in which the first image PG is being displayed.

With this configuration, in response to a selection operation performed by the user on the related image KG, the page image PG corresponding to the selected related image KG is displayed, and thereby the displaying of the page image PG of user's interest can be readily performed.

The display control method for the smart phone 1 may further include displaying a back icon IC2 for switching the displaying to the first image PG when switching the displaying to the second image PG in response to the selection operation.

With this configuration, a back icon IC2 for switching the displaying to the first page image PG is displayed, and thereby the display can be readily returned to the page image PG that was displayed before the page image PG of user's interest.

The display control method for the smart phone 1 may further include providing a thumbnail image group SSG including a plurality of thumbnail images SG aligned in the horizontal direction in the thumbnail image group display area HA1, and providing the first page image PG or the second page image PG in the page image display area HA2, in which the thumbnail image group SSG includes a first thumbnail image SG corresponding to the first page image PG and a second thumbnail image SG corresponding to the second page image PG.

With this configuration, the user can readily check the content of the page image PG corresponding to a thumbnail image SG of interest among thumbnail images SG in a thumbnail image group SSG.

The display control method for the smart phone 1 may further include switching the displaying of the second page image PG to a third page image PG in response to the switching operation on the second page image PG being displayed, and displaying a second related image KG corresponding to the third page image PG in response to a registration operation performed by the user on the third page image PG being displayed.

With this configuration, a related image KG corresponding each page image PG of interest is displayed, enabling the user to readily check the content of each desired page image PG.

The display control method for the smart phone 1 may further include maintaining the displaying of the related image KG during the displaying of the second related image KG.

With this configuration, related images KG corresponding page images PG of interest are simultaneously displayed, enabling the user to readily check the contents of the page images PG.

The display application 111 causes the processor 100 in the smart phone 1 to perform displaying a first page image PG, switching the displaying of the first page image PG to a second page image PG in response to a switching operation performed by a user, and displaying a related image KG corresponding to the second page image PG in response to a registration operation performed by the user on the second page image PG.

The display application 111 achieves effects similar to those according to the above-described display control method.

The smart phone 1 includes the touch panel 12 and the display control unit 101 configured to switch a first page image PG being displayed on the touch panel to a second page image PG in response to a switching operation received by the touch panel 12. The display control unit 101 displays a related image KG corresponding to the second page image PG in response to the touch panel 12 receiving a registration operation on the second page image PG.

The smart phone 1 achieves effects similar to those according to the above-described display control method.

The above-described embodiments are some aspects and their modifications and applications may be made.

The printer 2 may have functions other than the printing function, such as a scanning function and a facsimile function.

The display apparatus is not limited to the smart phone 1. The display apparatus may be a tablet PC, a desktop PC, or a laptop PC.

The operation unit and the display unit are not limited to the touch panel 12. The display unit may be a display including a light-emitting diode (LED) or an organic light-emitting diode (OLED). The operation unit may be a device that is coupled to an input unit, such as an operation switch, a mouse, or a keyboard, detects a user operation, and outputs the detection result to the controller 10.

The functions of the controller 10 may be implemented by a plurality of processors or semiconductor chips.

The components illustrated in FIG. 1 are merely examples and not particularly limited to these components. It is not always necessary to mount hardware corresponding to each component, and a single processor may execute a program to implement the functions of the components. Part of the functions implemented by software may be hardware, or part of the functions implemented by hardware may be implemented by software. Detailed specific configurations of other components of the smart phone 1 may be modified.

The step units of the operations illustrated in FIG. 7 and FIG. 8 are divided by major processing contents to facilitate understanding of the operations of the display control unit 101, and are not limited by the definition of the processing units or names. The step units may be divided into more steps in accordance with the processing contents. One step unit may be divided into more steps, and the order of steps may be changed appropriately.

What is claimed is:

1. A display control method for a display apparatus, the method comprising:
displaying a first image;
switching the displaying of the first image to a second image in response to a first operation performed by a user; and
displaying a related image corresponding to the second image in response to a second operation performed by the user on the second image being displayed.

2. The display control method according to claim 1, further comprising:
switching the displaying of the second image to the first image; and
switching the displaying of the first image to the second image in response to a third operation performed by the user on the related image in a state in which the first image is being displayed.

3. The display control method according to claim 2, further comprising:
displaying an icon for switching the displaying to the first image when switching the displaying to the second image in response to the third operation.

4. The display control method according to claim 1, further comprising:
providing a thumbnail image group including a plurality of thumbnail images aligned in a predetermined direction in a first area; and
providing the first image or the second image in a second area, wherein
the thumbnail image group includes a first thumbnail image corresponding to the first image and a second thumbnail image corresponding to the second image.

5. The display control method according to claim 1, further comprising:
switching the displaying of the second image to a third image in response to the first operation on the second image being displayed; and
displaying a second related image corresponding to the third image in response to a second operation performed by the user on the third image being displayed.

6. The display control method according to claim 5, further comprising:
maintaining the displaying of the related image during the displaying of the second related image.

7. A non-transitory computer-readable storage medium storing a program for causing a processor in a display apparatus to perform:
displaying a first image;
switching the displaying of the first image to a second image in response to a first operation performed by a user; and
displaying a related image corresponding to the second image in response to a second operation performed by the user on the second image.

8. A display apparatus comprising:
an operation unit configured to receive a user operation;
a display unit; and
a display control unit configured to switch a first image being displayed on the display unit to a second image in response to a first operation received by the operation unit, wherein
the display control unit causes a related image corresponding to the second image to be displayed in response to the operation unit receiving a second operation on the second image.
